(19) United States
(12) Patent Application Publication
(10) Pub. No.: US 2014/0026751 A1
(43) Pub. Date: Jan. 30, 2014

(54) SYSTEM AND METHOD FOR CAPTURING CARBON DIOXIDE FROM FLUE GAS

(71) Applicants: Ashok Kumar Anand, Schenectady, NY (US); Thirumala Reddy Nagarjuna Reddy, Bangalore (IN)

(72) Inventors: Ashok Kumar Anand, Schenectady, NY (US); Thirumala Reddy Nagarjuna Reddy, Bangalore (IN)

(73) Assignee: GENERAL ELECTRIC COMPANY, Schenectady, NY (US)

(21) Appl. No.: 13/557,666

(22) Filed: Jul. 25, 2012

(51) Int. Cl. B01D 53/02; F23G 7/06

(52) U.S. Cl. 95/139; 96/146; 432/72

(57) ABSTRACT

A system for capturing carbon dioxide from flue gas exhausted from a burner. The system may generally include a solid sorbent configured to absorb carbon dioxide at a first temperature and release carbon dioxide at a second temperature. In addition, the system may include a flue gas passage defining a flow path for the flue gas exhausted from the burner. The flow path may include an absorption zone in which the flue gas is at the first temperature and a regeneration zone in which the flue gas is at the second temperature. The solid sorbent may be cycled between the absorption zone and the regeneration zone such that carbon dioxide from the flue gas is absorbed by the solid sorbent within the absorption zone and released by the solid sorbent within the regeneration zone.

### FIELD OF THE INVENTION

The present subject matter relates generally to a system and method for capturing carbon dioxide and, more particularly, to a high temperature system and method for capturing carbon dioxide from the flue gas exhausted from a burner of a power plant.

### BACKGROUND OF THE INVENTION

As society becomes more conscious of the potential for global warming, attempts have been made to reduce the amount of carbon dioxide (CO₂) emitted into the atmosphere. Specifically, in fossil fuel burning power plants, attempts have been made to capture CO₂ at various points in time during the operating cycle of the various applications and systems within the power plant. The primary area in which conventional CO₂ capture systems are utilized is in the collection or capture of CO₂ from the exhaust or flue gas produced as a result of combustion within a power plant, such as in an Integrated Gasification Combined Cycle (IGCC) power plant. Typically, the flue gas is treated with a liquid-based solvent (e.g., an amine-based solvent) that absorbs the CO₂ contained within the gas. However, such liquid-based solvents must be at very low temperatures to absorb CO₂ from the flue gas. For example, a refrigeration system is typically required to cool the liquid-based solvent to an appropriate temperature for CO₂ capture, which necessitates large amounts of auxiliary power. As a result, a significant portion of the power generated by the power plant is used to operate the refrigeration system, thereby reducing the plant's overall power output and conversion efficiency. In addition, the liquid-based solvents must also be re-heated to release the CO₂ for disposal, thereby further increasing the amount of energy that must be expended to operate conventional CO₂ capture systems.

Accordingly, a system and method for capturing carbon dioxide from flue gas at high temperatures would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for capturing carbon dioxide from flue gas exhausted from a burner. The system may generally include a solid sorbent configured to absorb carbon dioxide at a first temperature and release carbon dioxide at a second temperature. In addition, the system may include a flue gas passage defining a flow path for the flue gas exhausted from the burner. The flow path may include an absorption zone in which the flue gas is at the first temperature and a regeneration zone in which the flue gas is at the second temperature. The solid sorbent may be cycled between the absorption zone and the regeneration zone such that carbon dioxide from the flue gas is absorbed by the solid sorbent within the absorption zone and released by the solid sorbent within the regeneration zone.

In another aspect, the present subject matter is directed to a power plant including a burner configured to produce a flue gas and a flue gas passage downstream of the burner defining a flow path for the flue gas. The flow path may include an absorption zone in which the flue gas is at a first temperature and a regeneration zone in which the flue gas is at a second temperature. In addition, the power plant may include a solid sorbent configured to absorb carbon dioxide at the first temperature and release carbon dioxide at the second temperature. The solid sorbent may be cycled between the absorption zone and the regeneration zone such that carbon dioxide from the flue gas is absorbed by the solid sorbent within the absorption zone and released by the solid sorbent within the regeneration zone.

In a further aspect, the present subject matter is directed to a method for capturing carbon dioxide from flue gas using a solid sorbent configured to absorb carbon dioxide at a first temperature and release carbon dioxide at a second temperature. The method may generally include exhausting flue gas from a burner into a flow path, the flow path including an absorption zone in which the flue gas is at the first temperature and a regeneration zone in which the flue gas is at the second temperature, transferring the solid sorbent through the absorption zone such that the solid sorbent absorbs carbon dioxide from the flue gas and transferring the solid sorbent through the regeneration zone such that the solid sorbent releases the carbon dioxide.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, schematic view of one embodiment of a power plant including a carbon dioxide capture system; and

FIG. 2 illustrates a simplified, schematic view of another embodiment of a power plant, particularly illustrating various additional components that may be included within the power plant shown in FIG. 1.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for capturing carbon dioxide (CO₂) from the flue gas exhausted from a burner of a power plant. Specifically, in several embodiments, the CO₂ capture system may include a solid sorbent configured to be cycled between separate absorption and regeneration zones of a flue gas passage positioned downstream of the burner. The solid sorbent may, for example, comprise a ceramic material or any other high temperature catalyst configured to absorb carbon dioxide from the flue gas at a first, relatively high temperature and release such carbon dioxide at a second, higher temperature. Such high temperature absorption and regeneration may generally allow for the overall efficiency of the power plant to be significantly improved. In particular, the disclosed CO₂ capture system may be capable of operating without the need for expensive refrigeration systems. As such, the large penalty in power production that typically results from the use of refrigeration systems may be avoided, thereby increasing the power output and conversion efficiency of the power plant as well as reducing the overall equipment costs for the power plant.

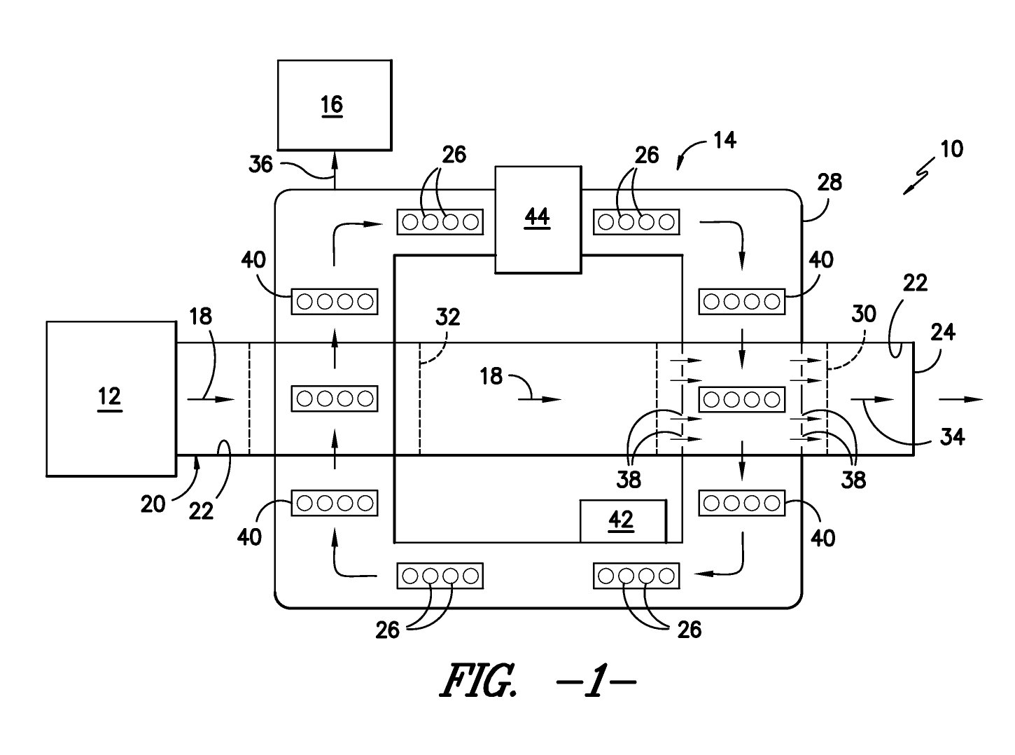

Referring now to FIG. 1, a simplified, schematic view of one embodiment of a power plant 10 is illustrated in accordance with aspects of the present subject matter. As shown, the power plant 10 generally includes a burner 12, a CO₂ capture system 14, and a CO₂ disposal system 16. In general, the burner 12 may form all or part of any suitable fossil fuel burning power system that is configured to combust or otherwise burn fossil fuels, thereby producing a CO₂ rich flue gas (indicated by arrows 18). For example, in one embodiment, the burner 12 may comprise one or more gas turbine combustors configured for use within a gas turbine or combined cycle power plant. In another embodiment, the burner 12 may comprise a boiler (e.g., a coal-fired or other combustion-fired boiler) configured for use within a steam turbine or combined cycle power plant. In other embodiments, the burner 12 may comprise any other suitable power plant component configured to combust or otherwise burn fossil fuels, such as furnaces, incinerators and/or any other suitable combustion systems.

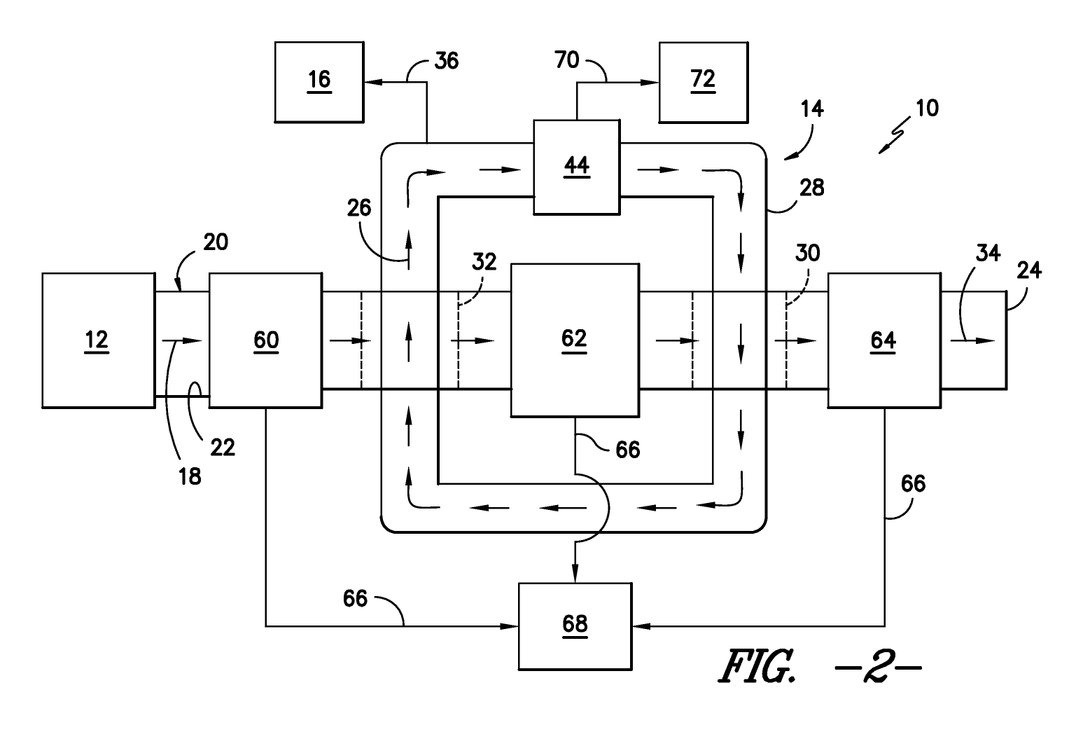

The flue gas 18 exhausted by the burner 12 may be directed into a flue gas passage 20. In general, the flue gas passage 20 may define a continuous flow path 22 for the flow of flue gas 18 between the burner 12 and an exhaust end 24 of the power plant 10 (i.e., the point at which the flue gas is expelled from the power plant 10). Thus, it should be appreciated that, as used herein, the term “flue gas passage” need not be limited to a single component defining a flow path for the flue gas 18 but may generally include any components disposed downstream of the burner 12 through which the flue gas 18 is directed as it flows from the burner 12 to the exhaust end 24 of the power plant 10. For instance, the flow path 22 formed by the flue gas passage 20 may be at least partially defined by any tubes, pipes, heat exchangers, scrubbers (or other cleaning devices), chambers, exhaust ducts, exhaust silos, cooling towers and/or any other suitable components positioned downstream of the burner 12 that receive and contain the flue gas 18 as its flows towards the exhaust end 24 of the power plant 10. Specifically, as will be described below with reference to FIG. 2, one or more steam generators 60, 62, 64 (FIG. 2) may be positioned downstream of the burner 12 in the flow path 22 of the flue gas 18. Thus, it should be appreciated that the portion of the steam generator(s) 60, 62, 64 through which the flue gas 18 is directed may generally form part of the flue gas passage 20.

Additionally, at least a portion of the CO₂ capture system 14 may be disposed in the flow path 22 of the flue gas passage 20 to allow for the capture and removal of the CO₂ contained within the flue gas 18. For example, in several embodiments, the CO₂ capture system 14 may comprise a closed-loop system in which a solid sorbent 26 is cycled within a sorbent container 28 between separate sections of the flue gas passage 20. Specifically, as shown in FIG. 1, the sorbent container 28 may form a closed-loop configured to intersect the flue gas passage 18 at a first downstream location 30 (hereinafter referred to as the “absorption zone 30” of the flow path 22) and a second downstream location 32 (hereinafter referred to as the “regeneration zone 32” of the flow path 22). In such an embodiment, the solid sorbent 26 may generally be configured to absorb CO₂ from the flue gas 18 as the sorbent 26 is transferred through the absorption zone 30, thereby converting the CO₂-rich flue gas 18 into a decarbonized flue gas (indicated by arrow 34) that may then be directed through the remainder of the flue gas passage 20 and expelled into the atmosphere at the exhaust end 24 of the power plant 10. In addition, the solid sorbent 26 may be configured to release the absorbed CO₂ as the sorbent 26 is transferred through the regeneration zone 32. This released CO₂ (indicated by arrow 36) may then be extracted from the sorbent container 28 and transmitted to the CO₂ disposal system 16 for disposal thereof. Thus, by cycling the solid sorbent 26 between the absorption and regeneration zones 30, 32, the sorbent 26 may continuously capture CO₂ from the flue gas 18 and release such CO₂ for subsequent disposal.

In general, the solid sorbent 26 used within the CO₂ capture system may comprise any suitable solid, regenerable material that is capable of absorbing and releasing CO₂. However, in several embodiments, the solid sorbent 26 may be selected based on its ability to absorb and regenerate CO₂ at the relatively high temperatures present within the flow path 22 of the flue gas passage 20. For example, the solid sorbent 26 may comprise a ceramic material, such as lithium silicate, calcium oxide, magnesium oxide and/or the like, and/or any other suitable high temperature catalyst (including any mixtures and/or combinations of high temperature catalysts) that is capable of absorbing and releasing CO₂ at temperatures at or above about 800° F. Specifically, in one embodiment, the solid sorbent 26 may be configured to absorb CO₂ at a first temperature ranging from about 800° F. to about 1300° F., such as from about 900° F. to about 1250° F. or from about 1050° F. to about 1250° F. and all other subranges therebetween, and release CO₂ at a second temperature above 1300° F., such as at a temperature ranging from greater than 1300° F. to about 1500° F. or from about 1350° F. to about 1500° F. and all other subranges therebetween.

In such an embodiment, the locations of the absorption and regeneration zones 30, 32 (i.e., the location at which the sorbent container 28 intersects the flue gas passage 20) may generally be selected so that the flue gas 18 is at the first temperature (e.g., within a temperature range of about 800° F. to about 1300° F.) as it flows through the absorption zone 30 and at the second temperature (e.g., at a temperature above 1300° F.) as it flows through regeneration zone 32. For example, as is generally understood, the temperature of the flue gas 18 may decrease as it flows along the flue gas passage 20 from the burner 12 to the exhaust end 24 of the power plant 10. Specifically, the temperature of the flue gas 18 exiting the burner 12 may often range from about 2400° F. to about 3000° F. while the temperature of the flue gas at the exhaust end 24 of the power plant 10 typically ranges from 150° F. to about 250° F. Thus, by carefully selecting the location of the absorption and regeneration zones 30, 32, the solid sorbent 26 may be exposed to flue gas 18 at the higher, second temperature as the sorbent 26 is transferred through the regeneration zone 32 and exposed to flue gas 18 at the lower, first temperature as the sorbent 26 is transferred through the absorption zone 30.

Additionally, in several embodiments, the sorbent container 28 may be configured such that the flue gas 18 flowing within the absorption zone 30 is directed through the container 28. Specifically, as shown in FIG. 1, the portion of the sorbent container 28 intersecting the absorption zone 30 may define a plurality of openings 38 (or may otherwise be configured to serve as a pass-through vessel for the flue gas 18) so that the flue gas 18 is directed through the sorbent container 28 as it flows along the flue gas passage 20. Thus, the flue gas 18 may be used to directly heat the solid sorbent 26 (via direct heat exchange) to the first temperature. Moreover, due to the direct contact between the solid sorbent 26 and the flue gas 18, the sorbent 26 may be capable of absorbing CO₂ from the flue gas 18 as it is transferred through the absorption zone 30. The decarbonized flue gas 34 expelled from the sorbent container 28 may then flow through the remainder of the flue gas passage 20 to the exhaust end 24 of the power plant 10.

Further, in several embodiments, the solid sorbent 26 may be configured to be indirectly heated by the flue gas 18 as it is transferred through the regeneration zone 32. Specifically, as shown in FIG. 1, the portion of the sorbent container 28 intersecting the regeneration zone 32 may be completely closed-off from the flow of flue gas 18. However, by directing the flue gas 18 over and/or around the sorbent container 28, the flue gas 18 may be used to indirectly heat the solid sorbent 26 (via indirect heat exchange) to the second temperature, thereby permitting the solid sorbent 26 to release the absorbed CO₂ within the sorbent container 28. This released CO₂ 36 may then be extracted from the sorbent container 28 and transmitted to the CO₂ disposal system 16 for disposal thereof.

It should be appreciated that the sorbent container 28 may generally comprise any suitable enclosure, vessel and/or container known in art through which the solid sorbent 26 may be transferred as it is cycled between the absorption and regeneration zones 30, 32. For example, in one embodiment, the sorbent container 28 may comprise a sealed chamber configured to form a closed-loop passageway for the solid sorbent 26. In addition, it should be appreciated that the solid sorbent 26 may be cycled between the absorption and regeneration zones 30, 32 using any suitable means known in the art. For example, as shown in FIG. 1, in one embodiment, the solid sorbent 26 may be placed in beds 40 and cycled within the sorbent container 28 using a suitable transfer mechanism 42, such as a closed-loop conveyor system.

Additionally, it should be appreciated that, although the CO₂ capture system 14 is shown in FIG. 1 as including a single closed-loop of solid sorbent 26, the CO₂ capture system 14 may generally include any number of closed-loops (including separate loops in parallel or series) for cycling the solid sorbent 26. For instance, in one embodiment, multiple, separate closed-loops of solid sorbent 26 may be cycled within the sorbent container 28 between the absorption and regeneration zones 30, 32. In another embodiment, the CO₂ capture system 14 may include multiple sorbent containers 28, with each sorbent container 28 including one or more closed-loops of solid sorbent 26 cycling between the absorption and regeneration zones 30, 32.

It should also be appreciated that the solid sorbent 26 may generally be formed into any suitable shape and/or object that allows it to capture CO₂ from the flue gas 18. For example, in several embodiments, the solid sorbent 26 may be formed into relatively small balls or pellets in order to increase the exposed surface area of the sorbent 26, thereby increasing its effectiveness to capture CO₂. However, in other embodiments, the solid sorbent 26 may be configured to have any other suitable form that allows it to effectively capture CO₂ from the flue gas 18 as it is transferred through the absorption zone 30.

Additionally, in several embodiments, the CO₂ capture system 14 may also include a heat recovery system 44 (e.g., any suitable heat exchanger) positioned between the regeneration zone 32 and the absorption zone 30. In general, the heat recovery system 44 may be configured to extract heat from the solid sorbent 26 as it is transferred from the regeneration zone 30 to the absorption zone 32 in order to allow for the continuous capture of CO₂ from the flue gas 18. Specifically, as indicated above, the solid sorbent 26 may be heated to the higher, second temperature as it is transferred through the regeneration zone 32 to allow for the release of the absorbed CO₂. However, to initially absorb the CO₂, the solid sorbent 26 must be at the lower, first temperature. Thus, the heat recovery system 44 may be utilized to cool the solid sorbent 26 to a suitable temperature (e.g., at or below the first temperature) in order to permit the sorbent to absorb CO₂ from the flue gas 18 as it is transferred through the absorption zone 30.

Referring still to FIG. 1, as indicated above, the CO₂ extracted from the sorbent container 28 may be directed to the CO₂ disposal system 16 of the power plant 10. In general, the disposal system 16 may comprise any suitable system known in the art for storing and/or disposing of sequestered CO₂. For example, in one embodiment, the disposal system 16 may include a CO₂ cooler (e.g., any suitable heat exchanger) configured to reduce the temperature of the CO₂ extracted from the sorbent container 28. In addition, the disposal system 16 may include a transport device (e.g., a pipeline) for transporting the CO₂ to a suitable storage location (e.g., an underground or deep sea storage location).

Referring now to FIG. 2, a simplified, schematic view of another embodiment of a power plant 10 is illustrated in accordance with aspects of the present subject matter, particularly illustrating additional components that may be included within the power plant 10 shown in FIG. 1. As shown, in addition to positioning the CO₂ capture system 16 along the flow path 22 of the flue gas passage 20, one or more steam generators 60, 62, 64 (e.g., one or more heat recovery steam generators) may also be disposed in the flow path 22. For example, as shown in the illustrated embodiment, the power plant 10 may include a first steam generator 60 disposed upstream of the regeneration zone 32, a second steam generator 62 disposed between the regeneration zone 32 and the absorption zone 30 and a third stream generator 64 disposed downstream of the absorption zone 30. However, it should be appreciated that, in alternative embodiments, the power plant 10 may generally include any number of steam generators 60, 62, 64 positioned at any suitable location along the flue gas passage 20.

As is generally understood, the steam generators 60, 62, 64 may be configured to extract heat from the flue gas 18 in order to generate steam (indicated by arrow 66). The steam 66 may then be delivered to one or more steam turbines 68 to drive a load (not shown), such as a generator. For example, in a particular embodiment of the present subject matter, the first steam generator 60 may be configured to generate high pressure steam for use within a high pressure steam turbine 68, the second steam generator 62 may be configured to generate intermediate pressure steam for use within an intermediate pressure steam turbine 68 and the third steam generator 64 may be configured to generator low pressure steam for use within a low pressure steam turbine 68.

Additionally, as shown in FIG. 2, in one embodiment, the heat recovery system 44 may also be used to generate steam (indicated by arrow 70). For instance, the heat extracted from the solid sorbent 26 may be used to generate steam 70 from a supply of feedwater (not shown) directed through the heat recovery system 44. The steam 70 may then be directed to one or more steam turbines 72 to drive a load (not shown).

It should be appreciated that, as indicated above, the present subject matter is also directed to a method for capturing CO₂ from flue gas 18 using a solid sorbent 26 configured to absorb CO₂ at a first temperature and release CO₂ at a second temperature. In one embodiment, the method may include exhausting flue gas 18 from a burner 12 into a flow path 22, wherein the flow path 22 includes an absorption zone 30 in which the flue gas 18 is at the first temperature and a regeneration zone 32 in which the flue gas 18 is at the second temperature. In addition, the method may include transferring the solid sorbent 26 through the absorption zone 30 such that the solid sorbent 26 absorbs CO₂ from the flue gas 18 and transferring the solid sorbent 26 through the regeneration zone 32 such that the solid sorbent 26 releases the CO₂.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for capturing carbon dioxide from flue gas exhausted from a burner, the system comprising:
a solid sorbent configured to absorb carbon dioxide at a first temperature and release carbon dioxide at a second temperature; and
a flue gas passage defining a flow path for the flue gas exhausted from the burner, the flow path including an absorption zone in which the flue gas is at the first temperature and a regeneration zone in which the flue gas is at the second temperature,
wherein the solid sorbent is cycled between the absorption zone and the regeneration zone such that carbon dioxide from the flue gas is absorbed by the solid sorbent within the absorption zone and released by the solid sorbent within the regeneration zone.

2. The system of claim 1, wherein the solid sorbent comprises at least one of lithium silicate, calcium oxide or magnesium oxide.

3. The system of claim 1, wherein the first temperature ranges from about 800° F. to about 1300° F.

4. The system of claim 1, wherein the second temperature ranges from about 1350° F. to about 1500° F.

5. The system of claim 1, wherein the absorption zone is downstream from the regeneration zone along the flue gas passage.

6. The system of claim 1, wherein the solid sorbent is heated by the flue gas through indirect heat exchange as the solid sorbent is transferred through the regeneration zone.

7. The system of claim 1, wherein the flue gas directly contacts the solid sorbent as the solid sorbent is transferred through the absorption zone.

8. The system of claim 1, further comprising a heat recovery system configured to reduce the temperature of the solid sorbent as the solid sorbent is transferred from the regeneration zone to the absorption zone.

9. A power plant comprising:
a burner configured to produce a flue gas;
a flue gas passage downstream of the burner defining a flow path for the flue gas, the flow path including an absorption zone in which the flue gas is at a first temperature and a regeneration zone in which the flue gas is at a second temperature; and
a solid sorbent configured to absorb carbon dioxide at the first temperature and release carbon dioxide at the second temperature, the solid sorbent being cycled between the absorption zone and the regeneration zone such that carbon dioxide from the flue gas is absorbed by the solid sorbent within the absorption zone and released by the solid sorbent within the regeneration zone.

10. The power plant of claim 9, wherein the burner comprises at least one of a gas turbine combustor or a boiler.

11. The power plant of claim 9, further comprising at least one steam generator disposed in the flow path.

12. The power plant of claim 9, wherein the solid sorbent comprises at least one of lithium silicate, calcium oxide or magnesium oxide.

13. The power plant of claim 9, wherein the first temperature ranges from about 800° F. to about 1300° F.

14. The power plant of claim 9, wherein the second temperature ranges from about 1350° F. to about 1500° F.

15. The power plant of claim 9, wherein the absorption zone is downstream from the regeneration zone along the flue gas passage.

16. The power plant of claim 9, wherein the solid sorbent is heated by indirect heat exchange as the solid sorbent is transferred through the regeneration zone.

17. The power plant of claim 9, wherein the flue gas directly contacts the solid sorbent as the solid sorbent is transferred through the absorption zone.

18. The power plant of claim 9, further comprising a heat recovery system configured to reduce the temperature of the solid sorbent as it is transferred from the regeneration zone to the absorption zone.

19. A method for capturing carbon dioxide from flue gas using a solid sorbent configured to absorb carbon dioxide at a first temperature and release carbon dioxide at a second temperature, the method comprising:
exhausting flue gas from a burner into a flow path, the flow path including an absorption zone in which the flue gas is at the first temperature and a regeneration zone in which the flue gas is at the second temperature;
transferring the solid sorbent through the absorption zone such that the solid sorbent absorbs carbon dioxide from the flue gas; and
transferring the solid sorbent through the regeneration zone such that the solid sorbent releases the absorbed carbon dioxide.

20. The method of claim 19, further comprising cooling the solid sorbent before it is transferred through the absorption zone.
